(19) United States
(12) Patent Application Publication
(10) Pub. No.: US 2013/0046598 A1
(43) Pub. Date: Feb. 21, 2013

(54) METHOD AND SYSTEM FOR PLACING AND COLLECTIVELY DISCOUNTING PURCHASE ORDERS VIA A COMMUNICATIONS NETWORK

(71) Applicant: Matthew P. Roberts, Ipswich, MA (US)

(72) Inventor: Matthew P. Roberts, Ipswich, MA (US)

(73) Assignee: Stack N' Save Inc., Ipswich, MA (US)

(21) Appl. No.: 13/588,744

(22) Filed: Aug. 17, 2012

Related U.S. Application Data
(60) Provisional application No. 61/524,447, filed on Aug. 17, 2011.

(51) Int. Cl. G06Q 30/02; G06Q 30/06

(52) U.S. Cl. 705/14.23

(57) ABSTRACT

Disclosed are a method and system for placing and collectively discounting purchase orders via a communications network. A collective discount platform, comprising engines and components, receives postponable purchase requests from client systems for an identified good with an undetermined transaction date. Once the postponable purchase requests meet an established criterion time constraints for receiving additional purchase requests are determined. When a time constraint is determined additional purchase requests may aggregate and discount the unit sale price for both postponable and additional purchase requests. When time constraints prohibit the aggregation of additional purchase requests individual payments are claimed from participating client systems.

### RELATED APPLICATION

This application claims the benefit of U.S. Provisional Application No. 61/524,447, filed on Aug. 17, 2011. The entire teachings of the above application are incorporated herein by reference.

### FIELD OF THE INVENTION

The present invention relates generally to a system for buying and selling products using a communications network, and more specifically, to a method and system for placing and collectively discounting purchase orders over the Internet, wherein decreasing marginal costs can be realized by requiring a minimum quantity of orders to be placed, as well as an additional time component, wherein additional orders beyond the minimum quantity of orders placed will be aggregated to provide a subsequent decreased sale price for all orders.

### BACKGROUND OF THE INVENTION

In recent years, many collective buying discount sites have connected people with the same demand for an item or service. The problem with previous sites is that the purchase and offering of a product is time sensitive and spontaneous. Setting a timeframe to attract a required minimum demand for a product is difficult and services and items may not sell or discount if the timeframe is too short. The spontaneity of products hosted results in impulse purchases and does not make these collective discount sites a reliable source for seeking a specific product. Also, many products are not suitable to be purchased impulsively, which limits the types of goods and services successfully sold by these sites. For suppliers, distributing goods through these sites may create problems and costs associated with forecasting order quantities and holding or producing adequate amounts of inventory to fulfill large customer orders in time.

It is well-recognized that pricing of a product for sale can be a function of a quantity of items to be purchased. A volume discount is a method used by sellers and manufacturers to reward those who are able to purchase in bulk amounts or in mass quantities. For manufacturers, customers that buy more of an item can be rewarded by a lower price because the manufacturer is able to purchase stock, and manufacture in quantity at a lower cost.

The average consumer can experience volume discounts on a regular basis. Most commonly, warehouse stores like Costco®, offer merchandise at lower prices because the merchandise is purchased in bulk quantities. However, volume discounts using this model typically require the customer to spend more than they may desire in order to obtain offered incentives or receive a lower purchasing unit price. In addition, buying on a projected demand can be risky and costly to customers if the product being purchased is perishable.

In recent years, many collective buying discount vehicles have connected people with the same demand for an item or service. Most commonly, volume discounting can be enabled and facilitated through cooperative purchasing made possible by the Internet, wherein groups of potential customers can place purchasing bids through a centralized database in a manner that will allow access to bulk discounts from suppliers.

For example, U.S. Pat. No. 7,672,897 discloses a method for enabling a community purchase model through the internet, wherein a product can be purchased at a particular price only if enough buyers are willing to purchase at that price. Collective purchase orders for a given product are pooled together to provide a discounted price. A computer system is used to collect a number of purchase orders, wherein the number of purchases is recorded in a specific product record and the transaction to purchase the product is consummated only if the number of purchase orders for the product reaches a minimum number. That patent also discloses the notion of setting a predetermined cutoff date for which the number of purchase orders may reach a minimum. If the cutoff date has been reached and the number of purchase orders for the product associated with the product record does not reach the minimum number, the product purchase is cancelled.

Heretofore, collective buying via demand aggregation may finalized by a cutoff date. The problem with previous approaches in this regard is that the purchase and offering of a product are time sensitive and spontaneous because the timeframe for discounting and receiving purchases is predetermined. Setting a timeframe to attract a required minimum demand for a product is difficult. Moreover, many services and items may not sell or discount if the timeframe is too short. The spontaneity associated with the purchase of products hosted may often result in impulse purchases and leads to unreliability in these collective discount sites with respect to customers seeking a specific product. Also, many products are not suitable to be purchased impulsively, which limits the types of goods and services successfully sold by these sites. For suppliers, distributing goods through these sites may create problems and costs associated with forecasting order quantities and holding or producing adequate amounts of inventory to fulfill large customer orders in time.

Somewhat similarly, U.S. Pat. No. 6,631,356 specifies a time interval for discount pricing defined by a price curve. Although this invention does not include a required aggregate demand minimum to generate orders, the specified time constraints may prohibit discounting from reaching substantial levels to compete with other discount retailers.

The present invention builds on this concept of collective purchasing and volume discounting by disclosing a method and system for enabling a community purchase model through the internet, wherein products can be purchased at an initial discounted price only if a sufficient number purchased orders are placed, and adding a time element or constraint for providing additional discounts for these products. The present invention provides for setting time constraints subsequent to a time at which a minimum number of purchase orders has been reached, wherein the subsequent time constraints permit the accumulation of additional purchase orders that, in turn, result in additional discounts for the customers.

### SUMMARY OF THE INVENTION

The methods and systems described herein take advantage of decreasing marginal costs in markets related to collective buying and determine when and how long a products should be discounted before transactions are generated. Products may accumulate a minimum collective demand or other collective demand criterion without a set timeframe. Commencing time constraints upon satisfying this minimum collective demand or other collective demand criterion provides a time window when increased economies of scale may be achieved.

When a minimum collective quantity demanded or other collective demand criterion has been reached, a discount period initiates and the length of said period may also be determined. During this discount period, additional orders may decrease the sale price for all customers. Upon the expiration of the discount period, transaction payments are claimed from individual customers contributing to the demand. The dates of the discount period and prices on the methods and systems may be determined by the demand for the product. This system allows for part of a collective demand to accumulate when a transaction date is undetermined. When a discount period with time constraints has commenced, additional orders may decrease the unit sale price for an identified product.

In one embodiment, the methods and systems may target the retail sector for manufactured goods, wherein the purchase of these items is postponable. The minimum order quantity set or other purchase request criterion may guarantee orders by a host and can be placed directly with manufacturers or distributors. Applications of the methods and systems described herein may also apply to travel, entertainment, and other service industries.

The methods and systems described herein take advantage of decreasing marginal costs in markets related to collective buying and determine when and how long a product should be discounted before transactions are generated. Products are given the adequate amount of time to accumulate a minimum collective demand order quantity, or other collective demand criterion without a set timeframe. Thereafter, a timeframe can establish for creating additional discounts based on the receipt of additional purchase requests or orders within that timeframe. By commencing time constraints once a predetermined collective demand criterion is met, transactions of demand can be generated in a timely manner, and an additional time window can be established in which increased economies of scales may be achieved.

Thus, the present invention provides a collective purchasing system and method, wherein a first discount price can be established when a minimum collective quantity or other collective demand criterion has been reached, which thereby initiates a subsequent discount period. During this subsequent discount period, additional orders may decrease the sale price for all customers. Upon the expiration of the subsequent discount period, transaction payments are claimed from individual customers contributing to the total demand. The dates of the subsequent discount period, and prices associated with accumulated purchase orders, may be determined, in part, by the demand for the product. This allows for a portion of a collective demand to accumulate when a transaction date is undetermined, and a subsequent discount period with time constraints that commences additional orders, which may lead to a decrease in the unit sale price for an identified product.

In one embodiment, the methods and systems may target the retail sector for manufactured goods, wherein the purchase of these items is postponable. The minimum predetermined order quantity, or other initial purchase request criterion, may guarantee that orders by a host system can be placed directly with manufacturers or distributors while achieving desired pricing. Applications of the methods and systems described herein may also apply to travel and entertainment industries.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates one embodiment of a network architecture for the collective discount platform;

FIG. 2 illustrates one embodiment of a software architecture for the collective discount platform;

FIG. 3 illustrates one embodiment of a flow diagram for the collective discount platform;

FIG. 4 illustrates one embodiment of a flow diagram for the collective discount platform;

FIG. 5 illustrates one embodiment of a data structure for the collective discount platform; and

FIG. 6 illustrates one embodiment of a system for the collective discount platform.

### DETAILED DESCRIPTION OF THE INVENTION

A description of example embodiments of the invention follows.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

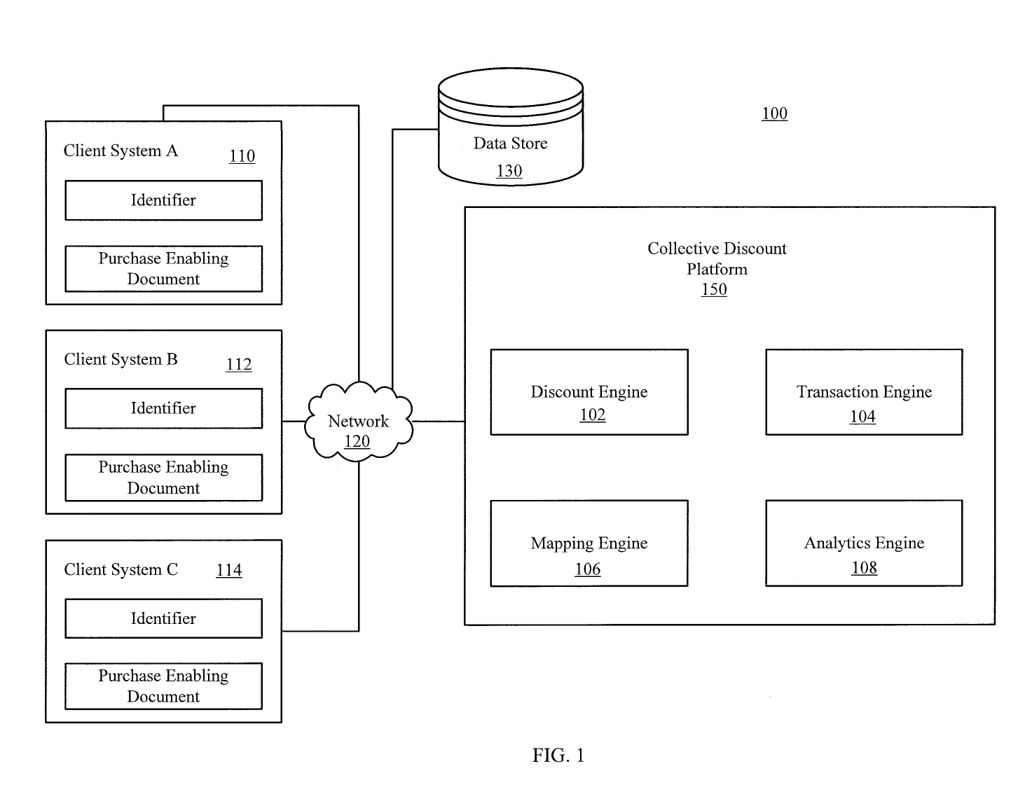

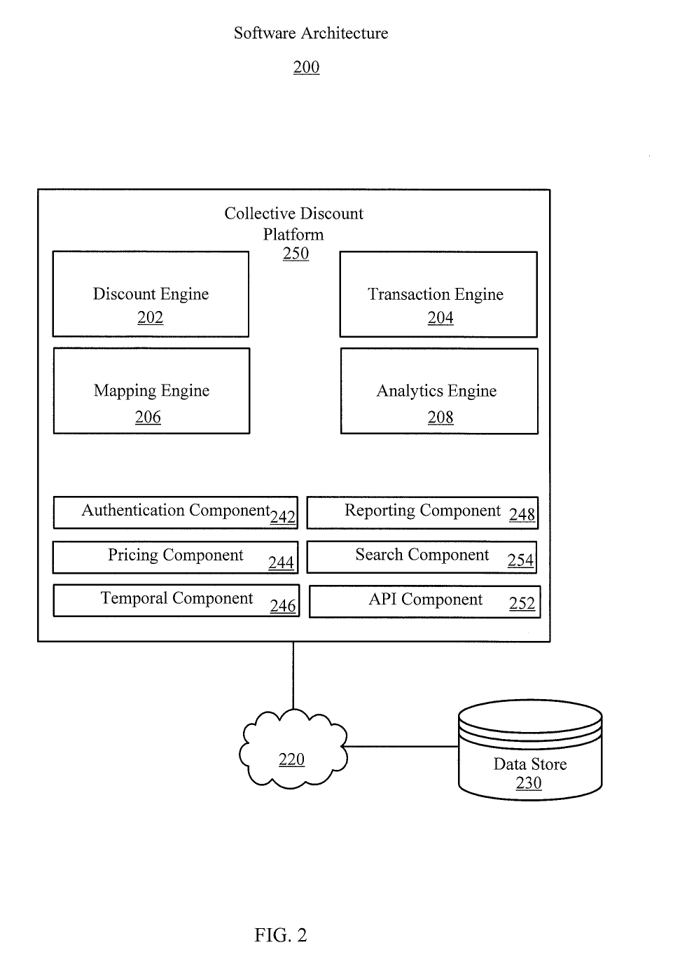

FIG. 1 illustrates one embodiment of a network architecture 100 for the collective discount platform 150. As illustrated in FIG. 1, the network architecture 100 may include a collective discount platform 150, a network 120, a client system A 110, a client system B 112, a client system C 114 and a data store 130, described with detail in FIG. 8. The collective discount platform 150 may include a discount engine 102, a transaction engine 104, a mapping engine 106 and an analytics engine 108, described with detail in FIG. 2.

A network 120 may include one or more physical and/or wireless networks. In one embodiment, the network may include a combination of LAN, WAN, Ethernet, token-ring, mesh, peer-to-peer and satellite networks. The combination of networks permits a variety of heterogeneous nodes to communicate using a variety of different protocols, e.g., TCP/IP, IPSec, UDP, HTTP, SSL, WiFi, Bluetooth, WAP and/or the like.

Client systems A-C 110, 112, 114 may be any suitable client device including a desktop, laptop and/or mobile device. Client systems may also comprise one or more client systems. In one embodiment, client systems may be in communication with a data store 130 and the collective discount platform 150 over a network 120. Each client system may further include an identifier and a purchase enabling document. An identifier is a unique value associated with the client system. The purchase enabling document may comprise an indicator of action, such as a button, to enable a purchase request for an identified item, a unit demand selection field, and order information relative to the disclosed system. This order information may include, the collective demand criterion to commence a discount period, the status of the current collective demand criterion, unit pricing, product details, graphics, a discount schedule, time constraints and a current sale price if the discount period has commenced. The required collective demand criterion may include one or more conditions that ensure an order placed by a host for the collective demand meets supplier purchase requirements to achieve desired product pricing. For example, one condition may require a minimum collective unit demand is achieved from received purchase requests. Often, suppliers entail an order minimum to receive a specific unit price for a good and requiring this minimum may ensure a desired unit price is achieved. The status of the current criterion may show how close customers are from achieving the required conditions to commence the discount period.

FIG. 2 illustrates one embodiment of a software architecture 200 for the collective discount platform 250. As illustrated in FIG. 2, the collective discount platform 250 may include a discount engine 202, a transaction engine 204, a mapping engine 206 and an analytics engine 208. The collective discount platform 250 may further include an authentication component 242, a pricing component 244, a temporal component 246, a reporting component 248, a search component 254 and an API component 252.

The discount engine 202 may discount and determine a unit sale price for a product activated with the collective discount platform and determine time constraints for discounting and receiving purchase requests. A purchase request is represented by the association of a customer's purchase information and individual unit demand with a collective discount platform. This association serves to manage individual customer demands for products. If the established criterion, such as a minimum collective unit demand, is met by purchase request enablers then the pricing component 244 initiates and a time constraint for receiving purchase requests is established.

In one embodiment, the discount engine and pricing component may determine a unit sale price during a discount period for an order listing activated with a collective discount platform. Determining the unit sale price includes establishing unit price/volume associations, processing marginal purchase requests, accumulating a total unit demand, setting unit price/volume mapping, and updating the unit sale price. In a preferred embodiment, a host determines price/volume associations to achieve a certain profit variable. For example, if a specific profit amount is desired, then all prices associated with volumes beyond the collective demand that realizes that amount may be determined by adding the marginal cost for a product to the outstanding revenue and dividing this amount by the collective demand. To clarify this example, a host can buy a product for $40 and desires a profit amount of $100 to execute a collective sale. The host may set a price of $50 when a collective demand is at 10 to achieve this profit amount. The price associated for a collective demand of 11 may be determined by the (outstanding revenue+marginal cost)/collective demand or (500+40)/11=49.1. The price associated with a collective demand of 12 may be determined by (540+40)/12=48.4. Alternatively, in another example, a specific profit margin may be realized by establishing price/volume associations with unit price reductions when economies of scale increase and marginal costs per a unit decrease.

In one embodiment, the pricing component 244 may allow a host to determine price/volume associations to achieve a certain profit variable. In a preferred embodiment, the unit demand volume and price associations may commence upon the determination of a discount period. A discount period may be determined based, at least in part, on the unit demand total. In one embodiment, the discount period is determined is based, at least in part, on mapped customer information, such as shipping addresses. The CD Platform may invoke the pricing component to price the sale upon the expiration of a discount period. In one embodiment, the collective discount platform may map relationships to calculate the individual payment prices for customers contributing to the purchase request total. In addition, the CD platform may further output an update to price information and communicate changes over the network to one or more engines or components.

In one embodiment, the discount engine is also in communication with a temporal component 246. The time constraints for discounting result in a discount period. These time constraints may be set by the determination of an initiation point and a length of time open for discounting and receiving purchase requests. In one embodiment, the discount engine 202 is in communication with a pricing component 244, wherein marginal purchase requests produce discounts for a product. The length of time constraints for operating the pricing component 244 and receiving purchase requests may be determined by the temporal component using information within the data store or conditions of collective discount offerings, historical and active.

The discount engine may also be in communication with the temporal component to determine the initiation and length of the discount period, wherein the pricing component determines a unit sale price and time constraints are effective for receiving purchase requests. In a preferred embodiment, the temporal component includes an established collective purchase request criterion that initiates the discount period. In a preferred embodiment, this criterion is set by a host and requires a minimum collective volume of units demanded are associated with the collective discount platform to ensure a minimum desired order quantity may be placed with a supplier. In a further embodiment, the criterion that initiates a discount period may further include conditions that respond to stored information.

For example, the criterion may require a specified number of purchase enabling customers have shipping addresses within a specific region. Information and conditions for determining the length of a time constraint may be defined by a host ensure that suppliers can fulfill the collective order on time and that customers are given the opportunity to achieve greater economies of scale. For example, determining the time constraint length may include using production information in the data store like daily output levels. If a collective order is for a minimum of 500 units and the supplier can produce 100 units daily then the time constraint may be at a minimum of 5 days. A further example for determining the length of a time constraint could include conditions of past collective discount platforms that may forecast the time needed for economies of scale to increase beyond the minimum requirements. If economies of scale were not able to increase beyond the minimum requirements after 10 days for a similar product, then the time constraint may be set longer than 10 days.

The transaction engine 204 may manage collective orders by authorizing, calculating and completing individual transaction payments. The transaction engine 204 may manage orders using customer purchase information and individual unit demands associated with the collective discount platform 250. In a preferred embodiment, identifiers are used to associate customer purchase information with the collective discount platform. The transaction engine 204 may calculate the individual payment price for each customer by using pricing and customer information retrieved from the data store and navigated via a mapping engine 206. Customer information retrieved from the data store 230 may include billing, shipping, and other information. In a preferred embodiment, the provided shipping information may be used to determine a shipping price for individual orders. In a preferred embodiment, a unit sale price, determined by the discount engine 202, is retrieved and multiplied by the individual units demanded by each purchase enabling customer to help determine individual payment prices. The transaction engine 204 may generate transaction payments and receipts by claiming the determined individual payment price for each purchase enabling customer using provided billing information. The individual payment price may include a multiple of the unit sale price, shipping charges, taxes, and other additional fees relating to individual customers.

The transaction engine may be in communication with an authentication component 242, wherein information saved in the data store 230 and provided for transaction payments may be authorized prior to claiming a payment. In a preferred embodiment, this verification may include placing authorizations on the provided billing information of purchase enabling customers with the appropriate financial service provider. In the case of a failed authorization, the transaction engine 204 may disassociate the identifier and units demanded of the customer providing invalid information with engines and components relative to the product identified for purchase. In a preferred embodiment, an authorization checkpoint is established prior to initiating a discount period. In one embodiment, the transaction engine 204 is in communication with a temporal component 246, wherein the calculation of a payment price and payment generation responds to the expiration of the discount period as derived from the discounting engine 202.

The mapping engine 206 assists other engines by retrieving and transmitting information from the data store. For example, the mapping engine may retrieve information for the determination of the discount period and transmit this information to the discount engine. The mapping engine may also retrieve purchaser information from the data store for transmission to the transaction engine, retrieve pricing information for transmission to the discount engine and retrieve order information for transmission to the analytics engine. The mapping engine 206 may be available to any of the engines and components to perform ad-hoc query requests on demand, at regularly scheduled intervals and/or at the occurrence of an event, e.g., the activation of a sale. In one embodiment, the mapping engine receives and maps relationships for customer purchase information and a unit demand for an identified product. For example, a client identifier associated with customer information is provided and stored by a client system, and sent to a collective discount platform for mapping relationships without submitting information on multiple occurrences.

The analytics engine 208 organizes and communicates information maintained in the collective discount platform to users of the platform. In one embodiment, the analytics engine 208 may be in communication with components for communicating data and information to supplying or customer entities. In one embodiment, the reporting component 248 may be in communication with the analytics engine to generate reports including, e.g., financial statements for sellers. Data Analytics may be transmitted to requesting users via any suitable format including document formats, spreadsheets, presentations, data visualization, graphics and/or the like media. For example, the daily increase in aggregate demand for a product could be displayed on a graph and information like the average daily demand could be disclosed in writing. Information and conditions of the engines and components of the CD Platform, active or historical, may be used to create analytical information that forecasts final order quantities and conditions, like an expected delivery timeframe for customers. Devices for accessing analytical information are not limited and may include computers, mobile phones, tablets, or any other device with an interface and a network connection.

An API component 252 provide one or more application programming interfaces (“APIs”) for developer clients to interface with the CD Platform and any users associated with the CD Platform and/or social networking website for which the hosting server provides one aspect of computing infrastructure. In some implementations, the CD platform may provide a wide variety of APIs for the developer clients. For example, the hosting server may provide APIs via which the developer system may obtain/modify/append user profile information, user data (e.g., e-mail, text messages, blog posts, microblogs, tweets, status messages/updates), user associated media content. The source code may include one or more API calls using APIs provided by the CD Platform. In such instances of compiling code including API calls, the developer server may query a database on a bundle corresponding to the input provided to the API call in the code. The engines and components may use and/or access the API through other engines and components to provide a non-hierarchical software architecture.

A reporting component 248 may generate an analytics report including updated prices and aggregate unit demand. This analytics report may be communicated on pending transaction documents sent to customers within a client account. In a preferred embodiment, time constraints for a discount period are also included in an analytics report if the discount period has been determined.

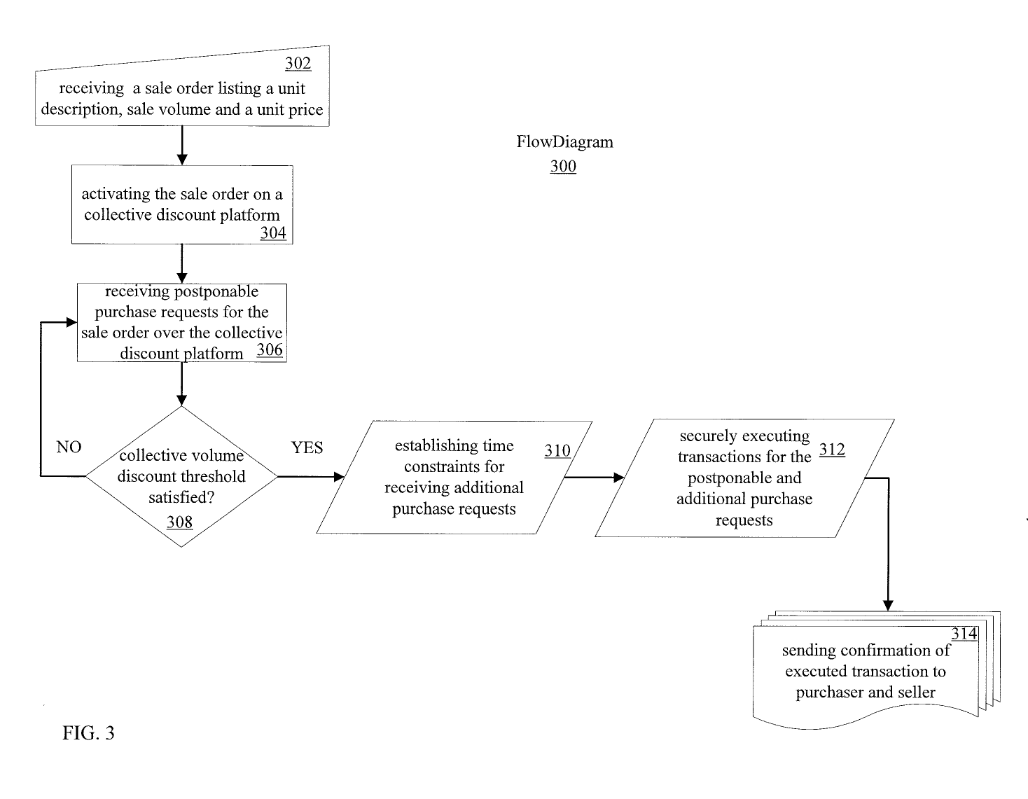

FIG. 3 illustrates one embodiment of a flow diagram 300 for the collective discount platform. As illustrated in FIG. 3, the collective discount platform may receive input 302. This input may include a sale order listing a unit description, sale volumes and unit pricing. The sale order listing may further include a seller's market description, a desired demographic, a minimum revenue value, a sale order capacity or limit and/or the like. The sale order listing may activate on a collective discount platform 304. In one embodiment, activating the sale order includes publishing the sale order on the collective discount platform site, portal and/or affiliate site. As illustrated in FIG. 3, the platform may receive postponable purchase requests for the sale order 306. Postponable purchase requests may be received by purchasers interested in purchasing a particular good or service at a predetermined maximum price with an undetermined transaction date. In one embodiment, the platform may determine if the collective volume discount threshold is satisfied 308. The threshold value may include a minimum volume number, a minimum profit value and/or the like. If the threshold value is met, then time constraints become effective for receiving additional purchase requests 310. When time constraints expire the platform may securely execute transactions for the purchase requests 312. As illustrated in FIG. 3, the platform may send confirmation of the executed transaction to a purchaser and a seller 314.

In one embodiment, this input 302 may include customer billing, shipping, and other stored information to generate transaction payments. In a preferred embodiment, order listings are activated on a collective discount platform 304 by a host. In one embodiment, the collective discount platform may generate a purchase document 304 and enable a purchase request. In one embodiment, a purchase document may be a document with an indicator of action, which enables a request of purchase that specifies the demand for one or more units of an identified item. In a preferred embodiment, for an indication of action, such as a purchase, to enable a purchase request, the appropriate inputs for completing transaction payments via the transaction engine may be checked for completeness and accuracy before or in coincident of the action indication.

In one embodiment, a purchase request is a represented by the association of customer purchase information and unit demand with the collective discount platform and is postponable under conditions wherein the time of transacting payments is undetermined and dependent on the demand of other customers. Purchase enablers may include customers who confirm the association of their purchase information and unit demand for a specified item with the collective discount platform.

The collective discount platform may also accumulate a new volume of collective units demanded associated with the platform. In one embodiment, the platform may set the demand volume and unit price mapping. The volume and unit price mapping may further require satisfaction of a criterion of purchase requests are met before the initiation of the mapping. In a preferred embodiment, the criterion required of purchase requests may include the condition that a minimum amount of collective units demanded be associated with the collective discount platform to ensure a desired quantity order may be placed with a supplier. In a further embodiment, the criterion of purchase requests may include geo-demographic conditions.

The collective discount platform may further output an update to price information and communicate collective demand changes over the network through one or more engines or components. In one embodiment, prices and the collective associated unit demand may be communicated on pending transaction documents sent to customers within their client accounts via the discount engine. The discount engine may transcribe and communicate updates on purchase documents to express current order conditions to potential customers. The discount engine may also determine to use a drop shipping approach permitting the distribution of goods with little to no inventory costs. In one embodiment, the supply end may monitor the demand for their products through the analytics engine.

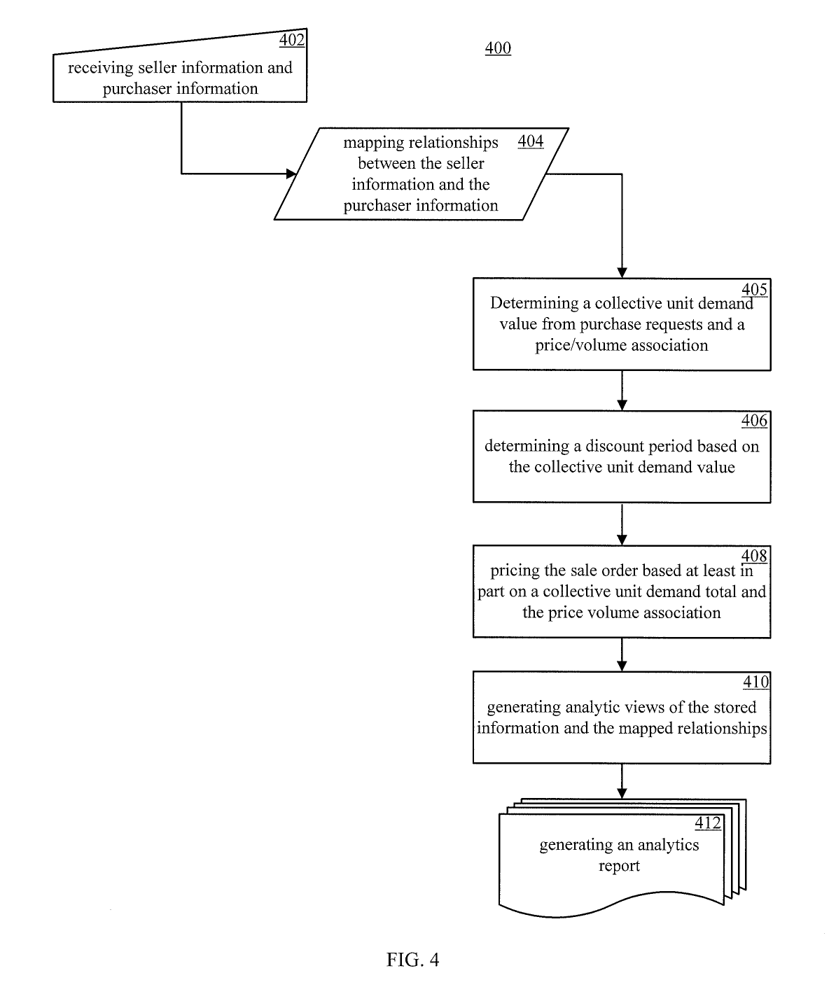

FIG. 4 illustrates one embodiment of a flow diagram 400 for the collective discount platform. As illustrated in FIG. 4, the collective discount platform may receive seller information and purchaser information 402. The CD Platform may also map relationships between the seller information and the purchaser information. These relationships may be represented as a data model (e.g., in XML, UML and other like data model formats). The flow of FIG. 4 also includes determining a unit demand total from purchase requests and price/volume associations 405. In one embodiment, the CD Platform may determine a discount period based on purchase requests, at least in part on the collective unit demand value 406. The CD Platform may also price the sale order based at least in part on the unit demand total and the price/volume associations 408. According to FIG. 4, the CD Platform may also generate analytic views of the stored information and the mapped relationships 410 and/or an analytics report 412.

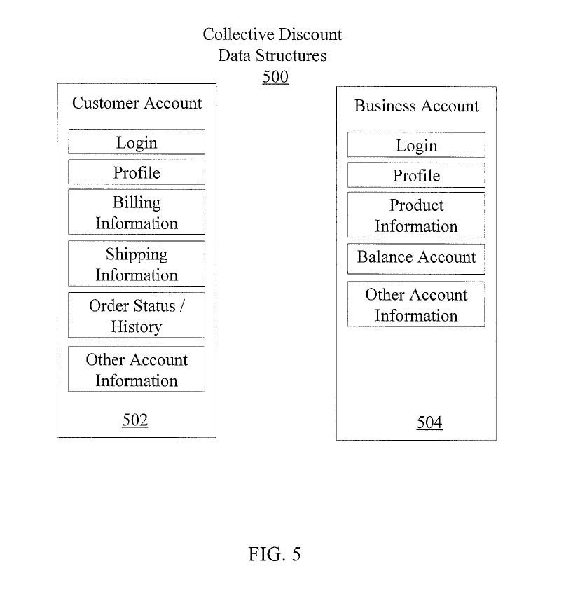

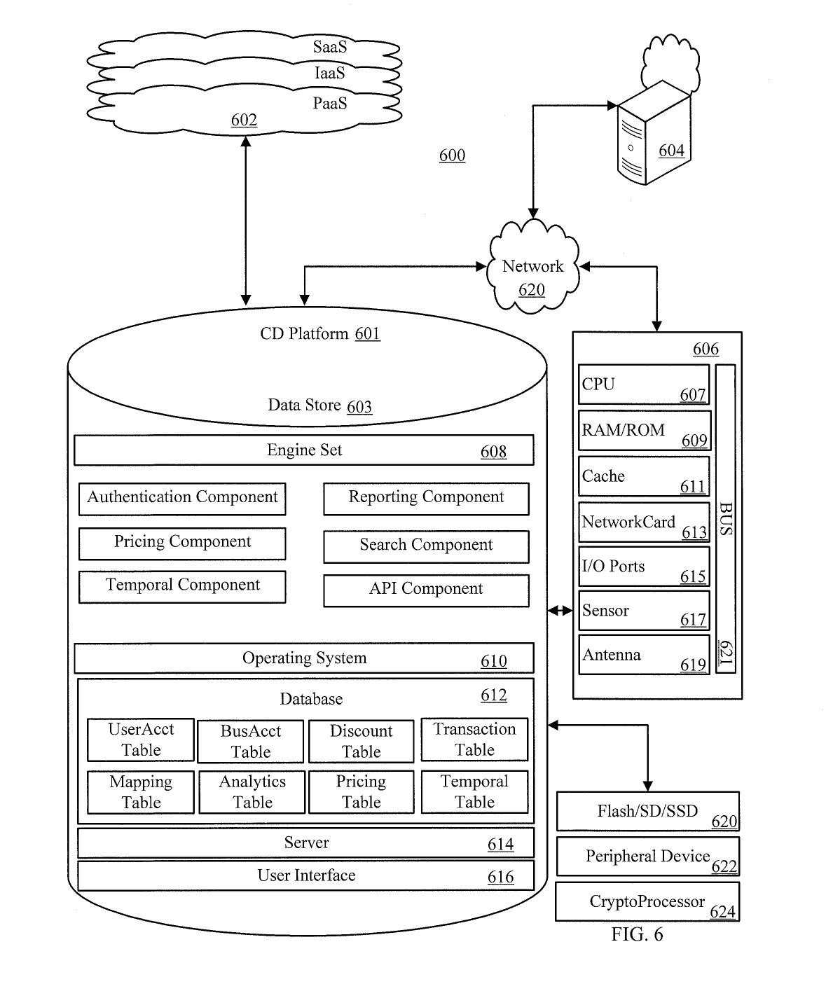

FIG. 5 illustrates one embodiment of data structures 500 for the collective discount platform. As illustrated in FIG. 5, a customer account data structure 502, wherein may exist a login, profile, order status and order history. In a further embodiment, an order status may include pending transaction documents that communicate the current order conditions of an underlying purchase request via an analytics engine. The customer account 502 may further include billing information, shipping information, and other account information. A business account data structure 504 may store a login, profile, balance account, order status, order history and/or the like. In a further embodiment, the order status may include pending order documents that communicate current and forecasted purchase request conditions via an analytics engine. The business account may further include product information and other account information. The customer account and business account data structure may be stored in one or more CD database(s), shown in FIG. 6.

The CD database may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CD database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the CD database is implemented as a data-structure, the use of the CD database may be integrated into the CD platform. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

FIG. 6 shows a block diagram illustrating embodiments of a CD Platform 601. In this embodiment, the CD Platform 601 may serve to aggregate, process, store, search, serve, identify, instruct, generate, match, and/or facilitate interactions with a computer. Typically, users, which may be people and/or other systems, may engage information technology systems (e.g., computers) to facilitate information processing. In turn, computers employ processors to process information; such processors 806 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CD platform 601 may be connected to and/or communicate with entities such as, but not limited to: one or more users from user input devices (e.g., Flash/SD/SSD 620); peripheral devices 622; an optional cryptographic processor device 624; and/or a communications network 620.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “client(s)” 604. The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CD Platform 601 may be based on one or more computer system(s) that may comprise a central processing unit 607 (“CPU(s)” and/or “processor(s)” (these terms are used interchangeable throughout the disclosure unless noted to the contrary)) 607, a memory (e.g., a read only memory (ROM), a random access memory (RAM) 609, Cache 611 etc.), and/or an Input/Output Ports 615, and may be interconnected and/or communicating through a system bus 621 on one or more (mother)board(s) having conductive and/or otherwise transportive circuit pathways through which instructions (e.g., binary encoded signals) may travel to effectuate communications, operations, storage, etc.

The computer systems may be connected to a power source; e.g., optionally the power source may be internal. Optionally, a cryptographic processor and/or transceivers (e.g., ICs may be connected to the system bus. In another embodiment, the cryptographic processor and/or transceivers may be connected as either internal and/or external peripheral devices 622 via the I/O ports 615. In turn, the transceivers may be connected to antenna(s) 619, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing CDP Platform controller to determine its location)); Broadcom BCM4329FKUBG transceiver chip (e.g., providing 802.11n, Bluetooth 2.1+EDR, FM, etc.); a Broadcom BCM47501UB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer system's circuit pathways. The clock is typically coupled to the system bus and various clock multipliers that will increase or decrease the base operating frequency for other components interconnected in the computer systems. The clock and various components in a computer system drive signals embodying information throughout the system. Such transmission and reception of instructions embodying information throughout a computer system may be commonly referred to as communications. These communicative instructions may further be transmitted, received, and the cause of return and/or reply communications beyond the instant computer system to: communications networks, input devices, other computer systems, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CDP and beyond through various interfaces. Should processing requirements dictate a greater amount speed and/or capacity, distributed processors (e.g., Distributed CDP) mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the CD platform may be achieved by implementing a microcontroller such as CAST's R8051XC2 microcontroller; Intel's MCS 51 (i.e., 8051 microcontroller); and/or the like. Also, to implement certain features of the CD platform, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CD Platform Engine Set 608 (distributed or otherwise) and/or features may be implemented via the microprocessor and/or via embedded components; e.g., via ASIC, coprocessor, DSP, FPGA, and/or the like. Alternately, some implementations of the CD Platform may be implemented with embedded components that are configured and used to achieve a variety of features or signal processing.

Depending on the particular implementation, the embedded components may include software solutions, hardware solutions, and/or some combination of both hardware/software solutions. For example, CD Platform features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CD Platform features. A hierarchy of programmable interconnects allow logic blocks to be interconnected as needed by the CD Platform system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the CD Platform may be developed on regular FPGAs and then migrated into a fixed version that more resembles ASIC implementations. Alternate or coordinating implementations may migrate CD Platform features to a final ASIC instead of or in addition to FPGAs. Depending on the implementation all of the aforementioned embedded components and microprocessors may be considered the “CPU” and/or “processor” for the CD Platform.

Interface bus(ses) 621 may accept, connect, and/or communicate to a number of interface adapters, conventionally although not necessarily in the form of adapter cards, such as but not limited to: input output interfaces (I/O) 615, storage interfaces, network card(s) 613, and/or the like. Optionally, cryptographic processor interfaces similarly may be connected to the interface bus. The interface bus provides for the communications of interface adapters with one another as well as with other components of the computer system. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network card(s) 613 may accept, communicate, and/or connect to a communications network 620. Through a communications network 620, the CD Platform is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CD Platform), architectures may similarly be employed to pool, load balance, and/or otherwise increase the communicative bandwidth required by the CD Platform.

A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

A cloud service 602 may be in communication with the CD platform 601. The cloud service may include a Platform-as-a-Service (PaaS) model layer, an Infrastructure-as-a-Service (IaaS) model layer and a Software-as-a-Service (SaaS) model layer. The SaaS model layer generally includes software managed and updated by a central location, deployed over the Internet and provided through an access portal.

The PaaS model layer generally provides services to develop, test, deploy, host and maintain applications in an integrated development environment. For example, the PaaS model layer may include a development interface to create, modify, test and deploy client user interfaces. The PaaS model generally employs a multi-tenant architecture where one or more concurrent users may work in a single instance of the development application. In one embodiment, scalability through load balancing and failover components may be included. Advantageously, the PaaS model generally includes support of integrating web services and database(s). For example, a PaaS model layer may provide a database service (DBaaS) as a storage solution through highly scalable non-relational or relational data store accessed through a query language (e.g., SQL, GQL, SOQL, PL/SQL, T-SQL and/or the like).

The IaaS layer model generally includes virtualization, virtual machines, e.g., virtual servers, virtual desktops and/or the like. A virtual machine may include a kernel-hosted virtual machine running UBuntu or CentOs which can launch approximately 8 virtual core instances allocating around 4 GB per virtual core. These virtual machines may include a set of storage options including an ephermal disk, a persistent disk and a cloud storage disk. Through the use of IaaS layer model services, the CD Platform can configure network parameters to isolate network traffic, configure a virtual firewall and securely transfer files.

Input Output interfaces (I/O) 615 may accept, communicate, and/or connect to user input devices, peripheral devices 622, cryptographic processor devices 624, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systems and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device 622 and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 622 may be connected and/or communicate to I/O and/or other facilities of the like such as network interfaces, storage interfaces, directly to the interface bus, system bus, the CPU, and/or the like. Peripheral devices may be external, internal and/or part of CD Platform. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the CD Platform may be embodied as an embedded, dedicated, and/or monitor-less (i.e., headless) device, wherein access would be provided over a network interface connection.

Cryptographic units such as, but not limited to, microcontrollers, processors, interfaces, and/or devices may be attached, and/or communicate with the CD Platform. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the CD Platform and/or a computer systems may employ various forms of memory. For example, a computer systems may be configured wherein the operation of on-chip CPU memory (e.g., registers), RAM, ROM 609, and any other storage devices are provided by a paper punch tape or paper punch card mechanism; however, such an embodiment would result in an extremely slow rate of operation. In a typical configuration, memory will include ROM, RAM, and a storage device 603. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systems generally requires and makes use of memory.

Engine Set

The memory may contain a collection of program and/or database components and/or data such as, but not limited to: operating system component(s) (operating system 610); information server component(s) (information server); user interface component(s) (user interface 616); Web browser component(s) (Web browser); database(s) 519; mail server component(s); mail client component(s); cryptographic server component(s) 520 (cryptographic server); the CD Platform; and/or the like (i.e., collectively a Engine set collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

The operating system component 610 is an executable program component facilitating the operation of the CD Platform. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CD Platform to communicate with other entities through a communications network 620. Various communication protocols may be used by the CD Platform as a subcarrier transport mechanism for interaction, such as, but not limited to: multicast, TCP/IP, UDP, unicast, and/or the like.

An information server 614 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CD Platform based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CD Platform database 612, operating systems, other program components, user interfaces, Web browsers, and/or the like.

Access to the CD Platform database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CD Platform. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CD Platform as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser. Also, an information server may contain, communicate, generate, obtain, and/or provide program component, system, user, and/or data communications, requests, and/or responses.

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 616 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

A Web browser component (not shown) is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the CD Platform enabled nodes. The combined application may be nugatory on systems employing standard Web browsers.

A mail server component (not shown) is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the CD Platform. Access to the CD Platform mail may be achieved through a number of APIs offered by the individual Web server components and/or the operating system. Also, a mail server may contain, communicate, generate, obtain, and/or provide program component, system, user, and/or data communications, requests, information, and/or responses.

The structure and/or operation of any of the CD Platform may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The Engine Set components may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CD Platform will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If Engine Set components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims.

### OTHER EMBODIMENTS

As noted above, FIG. 1 illustrates one embodiment of a network architecture for a host system 100 that can facilitate the collective discount platform 150 of the present invention. As illustrated in FIG. 1, the network architecture 100 may include a collective discount platform 150, a network 120, a plurality of client systems, such as a client system A 110, a client system B 112, a client system C 114 and a data store 130. The collective discount platform 150 may include a discount engine 102, a transaction engine 104, a mapping engine 106 and an analytics engine 10.

The network 120 may include one or more physical and/or wireless networks. In one embodiment, the network may include a combination of LAN, WAN, Ethernet, token-ring, mesh, peer-to-peer and satellite networks. The combination of networks permits a variety of heterogeneous nodes to communicate using a variety of different protocols, e.g., TCP/IP, IPSec, UDP, HTTP, SSL, WiFi, Bluetooth, WAP and/or the like. 8, described with detail in FIG. 2.

Client systems A-C 110, 112, 114 may be any suitable client device including a desktop, laptop and/or mobile device. Client systems may also comprise one or more client systems. In one embodiment, client systems may be in communication with a data store 130 and the collective discount platform 150 over a network 120. Each client system may further include an embedded identifier and a purchase enabling document, or means for automatically or manually creating the same. An identifier is a unique value associated with the client system. The purchase enabling document may comprise an indicator of action, such as a button, to enable a purchase request or a purchase order issued by a buyer to a supplier, indicating types, quantities, and agreed prices for products or services that the supplier will provide to the buyer dependent on the demand for products or services. The purchase request or order is used as the vehicle for controlling the purchase of an identified item. The purchase enabling document may also include, but not limited to, a unit demand selection field, and order information relative to the purchaser and/or seller. Importantly, this order information may also include: the collective demand criterion to commence a discount period; the status of the current collective demand criterion, the initial unit price, additional unit pricing; product details; graphics; a discount schedule; and time constraints and a current price if a discount period has commenced. The collective demand criterion may include one or multiple conditions that ensure an order placed via the client systems 110, 112, 114 to the host system 100 for the collective discount meets supplier purchase requirements to achieve desired product pricing. For example, one condition may require that a minimum collective unit quantity demand is achieved from received purchase requests. Often, suppliers will require an order minimum for customers to receive a specific unit price for specific goods or services. Requiring this minimum may ensure a desired unit price is achieved for the customer and is typically determined by the economies of scale that can be obtained by the manufacturer of service provider. A status of the current criterion may be provided as in indication to show how close customers are to achieving the required conditions to commence a subsequent discount period.

As noted above, FIG. 2 illustrates one embodiment of a software architecture 200 for the collective discount platform illustrate in FIG. 1. As illustrated in FIG. 2, the collective discount platform 250 may include a discount engine 202, a transaction engine 204, a mapping engine 206 and an analytics engine 208. The collective discount platform 250 may further include an authentication component 242, a pricing component 244, a temporal component 246, a reporting component 248, a search component 254 and an Application Programming Interface (API) component 252.

The discount engine 202 may discount and determine a unit sale price for a product ordered or requested over the collective discount platform and determine time constraints for subsequently received additional purchase requests and for providing subsequent discount pricing. The time constraints for subsequent discounting result in a discount period. A purchase request is represented by the association of a customer's purchase information and individual unit demand with the collective discount platform and is postponable, wherein time constraints have not commenced. This association serves to manage individual customer demands for products. In one embodiment, the discount engine 202 is in communication with a pricing component, wherein additional or marginal purchase requests produce discount for a product. In one embodiment, the discount engine is also in communication with the temporal component 246, which establishes criterion for collective purchase requests. If the established criterion, such as a minimum collective unit demand value, is met by purchase request enablers then the pricing component 244 initiates and a time constraint for receiving additional purchase requests is established.

In one embodiment, the discount engine 202 and pricing component 244 may determine a unit sale price during a discount period for a sale order listing activated with the collective discount platform 250. Determining a unit sale price may include establishing unit price/volume associations, processing marginal purchase requests, accumulating a total unit demand from the marginal and postponable purchase requests, setting unit price/volume mapping, and updating the unit sale price. In a preferred embodiment, the host 100 determines price/volume associations for the pricing component 244 to achieve a certain profit variable. For example, if a specific profit amount is desired, then all prices associated with volumes beyond the collective demand that realizes that amount may be determined by adding the marginal cost for a product to the outstanding revenue and dividing this amount by the collective demand. To clarify this example, assume that the host can buy a product for $40 and desires a profit amount of $100 to execute a collective sale. The host may set a price of $50 when a collective demand quantity is at 10 in order to achieve this profit amount. The price associated for a collective demand of 11 may be determined by the (outstanding revenue+marginal cost)/collective demand or (500+40)/11=49.1. The price associated with a collective demand of 12 may be determined by (540+40)/12=48.4. Alternatively, in another example, a specific profit margin may be realized by establishing price/volume associations with unit price reductions only when economies of scale increase and marginal costs per unit decrease by a predetermined amount.

In a preferred embodiment, the unit demand volume and price associations may commence upon the determination of a subsequent discount period. A discount period may be determined based on a collective unit demand. In one embodiment, the collective unit demand may be a unit demand aggregated from purchase requests for customers with certain mapped customer information, such as shipping addresses within specified region. The collective discount platform may invoke the pricing component to price the sale upon the expiration of a discount period. In one embodiment, the collective discount platform may map relationships to calculate the individual payment prices for customers contributing to the purchase request total. In addition, the collective discount platform may further output an update to price information and communicate changes over the network to one or more engines or components.

In a preferred embodiment, the discount engine 202 is associated with the temporal component 246 for determining time constraints for the subsequent discount period, wherein the pricing component determines a unit sale price and additional purchase requests may be received by the collective discount platform. These time constraints may be set by the determination of an initiation point and a length of time open for discounting and receiving purchase requests. In a preferred embodiment, the temporal component 246 establishes a criterion, such as a collective unit demand value, for received postponable purchase requests to initiate the discount period. In a preferred embodiment, this criterion is determined by the host 100 and requires that a minimum collective volume of units demanded are associated with the collective discount platform to ensure a minimum desired order quantity may be placed with a supplier. In a further embodiment, the criterion that initiates a discount period may further include conditions that respond to purchaser information associated with collective discount platform 250. For example, the criterion may require that a specified number of purchase enabling customers have shipping addresses within a specific region to ensure a geo-demographic is achieved. In a preferred embodiment, purchaser information is associated with the collective discount platform 250 using an identifier provided by one of the plurality of client systems 110, 112, 114.

The length of time constraints for operating the pricing component 244 and receiving purchase requests may be established by the temporal component 246 using information within the data store or conditions of collective discount offerings, historical and active. In a preferred embodiment, the information and conditions for determining the length of the time constraint are defined by the host to ensure that suppliers can fulfill the collective order on time and that customers are given the opportunity to achieve greater economies of scale. For example, determining the time constraint length may include using production information like daily output levels in the data store 230. For example, if a collective order is for a minimum of 500 units and the supplier can produce 100 units daily, then the time constraint may be at a minimum of 5 days. A further example for determining the length of a time constraint could include conditions of past collective discount platforms that may forecast the time needed for economies of scale to increase beyond the minimum requirements. If economies of scale were not able to increase beyond the minimum requirements after 10 days for a similar product then the time constraint may be set longer than 10 days.

The transaction engine 204 may manage collective orders by authorizing, calculating and completing individual transaction payments. The transaction engine 204 may manage orders using customer purchase information and individual unit demands associated with the collective discount platform 250. In a preferred embodiment, identifiers are used to manage the association of customer purchase information with the collective discount platform 250. The transaction engine 204 may calculate the individual payment price for each purchase request enabling customer by using pricing and purchaser information retrieved from the data store and navigated via the mapping engine 206. Purchaser or customer information, which may be retrieved from the data store 230, may include billing, shipping, and other information. In a preferred embodiment, the provided shipping information may be used to determine a specified shipping price for certain individual orders or purchase requests. In a preferred embodiment, a unit sale price, determined by the discount engine 202, is retrieved and multiplied by the individual units demanded by each purchase enabling customer to help determine individual payment prices. The transaction engine 204 may generate transaction payments and receipts by claiming the determined individual payment price for each purchase, thereby enabling customers using provided billing information. In addition, the individual payment price may include a multiple of the unit sale price, shipping charges, taxes, and other additional fees relating to individual customers.

The transaction engine may be in communication with an authentication component 242, wherein information saved in the data store 230 and provided for transaction payments may be authorized prior to claiming a payment. In a preferred embodiment, this verification may include placing authorizations on the provided billing information of purchase enabling customers with the appropriate financial service provider. In the case of a failed authorization, the transaction engine 204 may disassociate the purchaser information r and units demanded of the customer providing invalid information with engines and components relative to the product identified for purchase. In a preferred embodiment, an authorization checkpoint is established prior to initiating a subsequent discount period. In one embodiment, the transaction engine 204 is in communication with a temporal component 246, wherein the calculation of a payment price and payment generation responds to the expiration of the discount period as derived from the discounting engine 202.

The mapping engine 206 assists other engines by retrieving and transmitting information with and between the data store and collective discount platforms. For example, the mapping engine may retrieve information for the determination of the discount period and transmit this information to the discount engine. The mapping engine may also retrieve purchaser information from the data store for transmission to the transaction engine, retrieve pricing information for transmission to the analytics engine, and retrieve order information for transmission to the analytics engine. Also, the mapping engine may retrieve and transmit information of a collective discount platform condition to another collective discount platform. The mapping engine 206 may be available to any of the engines and components to perform ad-hoc query requests on demand, at regularly scheduled intervals and/or at the occurrence of an event, e.g., the activation of a sale. In one embodiment, the mapping engine receives and maps relationships for customer purchase information and a unit demand for an identified product. For example, a client identifier associated with customer information is provided and stored by a client system, and sent to a collective discount platform for mapping relationships without submitting information on multiple occurrences.

The analytics engine 208 organizes and communicates information maintained in the collective discount platform to users of the platform and, in a further embodiment, other collective discount platforms. In one embodiment, the analytics engine may be in communication with components for communicating data and information to supplying or customer entities. In one embodiment, the reporting component 248 may be in communication with the analytics engine to generate reports including, e.g., financial statements for sellers. Data Analytics may be transmitted to requesting users via any suitable format including document formats, spreadsheets, presentations, data visualization, graphics and/or the like media. For example, the daily increase in aggregate demand for a product could be displayed on a graph and information like the average daily demand could be disclosed in writing. Information and conditions of the engines and components of the collective discount platform, active or historical, may be used to create analytical information that forecasts final order quantities and conditions, like an expected delivery timeframe for customers. Devices for accessing analytical information are not limited and may include computers, mobile phones, tablets, or any other device with an interface and a network connection.

An API component 252 provide one or more application programming interfaces (“APIs”) for developer clients to interface with the collective discount platform and any users associated with the collective discount platform and/or social networking website for which the hosting server provides one aspect of computing infrastructure. In some implementations, the collective discount platform may provide a wide variety of APIs for the developer clients. For example, the hosting server may provide APIs via which the developer system may obtain/modify/append user profile information, user data (e.g., e-mail, text messages, blog posts, microblogs, tweets, status messages/updates), user associated media content. The source code may include one or more API calls using APIs provided by the collective discount platform. In such instances of compiling code including API calls, the developer server may query a database on a bundle corresponding to the input provided to the API call in the code. The engines and components may use and/or access the API through other engines and components to provide a non-hierarchical software architecture.

A reporting component 248 may generate an analytics report including updated prices and aggregate unit demand. This analytics report may be communicated on pending transaction documents sent to customers within a client account. In a preferred embodiment, time constraints for a discount period are also included in an analytics report if the discount period has been determined.

As noted above, FIG. 3 includes an exemplary embodiment of a flow diagram 300 is illustrated for providing a schematic representation of a process to be implemented on the collective discount platform of the present invention. As illustrated in FIG. 3, the collective discount platform may receive input 302 for activating the sale order 304. This input may include a sale order listing a unit description, a unit price, and a sale volume for units. The sale order listing may further include a seller's market description, a desired demographic, a minimum revenue value, a sale order capacity or limit and/or the like. The sale order listing may activate on the collective discount platform 304. In one embodiment, activating the sale order includes publishing the sale order on website, portal and/or affiliate site associated with the collective discount platform. As illustrated in FIG. 3, at step 306, the platform may receive postponable purchase requests for the sale order. Postponable purchase requests may be received by purchasers interested in purchasing a particular good or service at a predetermined maximum price with an undermined transaction date. In one embodiment, the platform may determine if the collective volume discount threshold or collective unit demand value is satisfied, as shown at step 308. The threshold value may include a minimum volume number, a minimum profit value and/or the like. If the threshold value is met, then time constraints establish for subsequently receiving additional-purchase requests, as shown at step 310. Preferably, in accordance with the present invention, these additional purchase requests will trigger subsequent discounts. When time constraints expire, the platform may securely execute transactions for the purchase requests, at step 312. Finally, as illustrated in FIG. 3, at step 314, the platform may send confirmation of the executed transaction to a purchaser and a seller.

In one embodiment, this input step 302 may include supplier or seller information, sale unit volumes, unit pricing, production information, and any other information relevant to placing an order using the present invention. In a preferred embodiment, sale order listings are activated at step 304 on a collective discount platform by a host. In one embodiment, the collective discount platform may generate a purchase document and enable a purchase request. In one embodiment, a purchase document may be a document with an indicator of action, which enables a request of purchase that specifies the demand for one or multiple units of an identified item. In a preferred embodiment, for an indication of action, such as a purchase, to enable a purchase request, the appropriate inputs for completing transaction payments via the transaction engine may be checked for completeness and accuracy before or coincident with the action indication.

In one embodiment, a purchase request is a represented by the association of customer purchase information and an individual unit demand with the collective discount platform and is postponable until conditions dependent on the demand and or purchase requests of other customers. In a preferred embodiment, identifiers may be used for associations with the collective discount platform. Also, in one embodiment, purchase enablers may include customers who confirm the association of their purchase information and unit demand for a specified item with the collective discount platform.

The collective discount platform may also accumulate a new volume of collective units demanded and associated with the platform, combined from postponable and/or additional purchase requests. In one embodiment, the platform may set the demand volume and unit price mapping. The volume and unit price mapping may further require satisfaction of a criterion of postponable purchase requests are met before the initiation of the mapping. In a preferred embodiment, a criterion required of purchase requests may include the condition that a minimum amount of collective units demanded are associated with the collective discount platform to ensure a desired quantity order may be placed with a supplier. In a further embodiment, the criterion of purchase requests may include stored information associated with the collective discount platform ensure specific demographic conditions.

The collective discount platform of the present invention may further output an update to price information and communicate a collective demand over the network transmitted to one or more engines or components. In one embodiment, prices and the collective associated unit demand may be communicated on pending transaction documents sent to customers within their client accounts via the analytics engine. In one embodiment, the analytics engine may transcribe and communicate updates on purchase documents to express current order conditions to potential customers. The host may determine to use a drop shipping approach permitting the distribution of goods with little to no inventory costs. In one embodiment, the supply end may monitor the demand for their products through the analytics engine and an enterprise reporting platform.

As noted above, FIG. 4 illustrates one embodiment of a flow diagram 400 for the process steps carried out on the collective discount platform of the present invention. As illustrated in FIG. 4, the collective discount platform may receive seller information and purchaser information at step 402. The collective discount platform may also map relationships between the seller information and the purchaser information at step 404. These relationships may be represented as a data model (e.g., in XML, UML and other like data model formats). The flow diagram of FIG. 4 includes a step 405 for determining a collective unit demand value from purchase requests and a price-volume association. In one embodiment, the collective discount platform may determine a discount period based on the collective unit demand value at step 406. At step 408, the collective discount platform may also price the sale order based at least in part on a collective unit demand total and the price/volume association. According to FIG. 4, the collective discount platform may also generate analytic views of the stored information and the mapped relationships and/or an analytics report at steps 410 and 412.

In a preferred embodiment, the collective discount platform receives and maps relationships for customer purchase information and a unit demand for an identified product. In one embodiment, purchaser information may include customer billing, shipping, and other information stored for generating transaction payments. In one embodiment, identifiers are used for mapping relationships for the collective discount platform. In one embodiment, a client identifier associated with customer information is provided and stored by a client system, and sent to a collective discount platform for mapping relationships without submitting information on multiple occurrences. Identifiers enable steps of the flow, including the determination of a discount period, price/volume mapping, generating analytic views, and reporting analytics, to be executed without submitting or verifying sensitive information used to generate transactions on multiple occurrences. In effect, an indication of action for a purchase request by one customer may initiate a discount period, update a unit price, and generate an analytic report with update order conditions for participating and potential customers without submitting or verifying sensitive purchase information. In one embodiment, the retrieval and transmission of order information, including the unit sale price determined by the discount engine, for generating transactions may be completed via a mapping engine. In a preferred embodiment, a host determines price/volume associations to achieve a certain profit variable. In a preferred embodiment, the unit demand volume and price association mapping may commence upon the determination of a subsequent discount period. In a preferred embodiment, a subsequent discount period is determined based on a collective unit demand value. In one embodiment, the collective unit demand value or criterion could be the collective unit demands of customers with certain purchaser information mapped from purchase requests, such as shipping addresses within a geographic region. In one embodiment, the collective unit demand total includes the combined unit demands from all postponable purchase requests and additional purchase requests for a sale order. In a preferred embodiment, the collective discount platform may price the sale upon the expiration of a discount period and claim individual customer payments. In one embodiment, the collective discount platform may map relationships to calculate the individual payment prices for customers contributing to the purchase request total.

In one embodiment, the collective discount platform may further output an update to price information on an analytics report sent in documents over the network to one or more engines. In a preferred embodiment, an analytics report includes updated prices and aggregate unit demand, and may be communicated on pending transaction documents sent to customers within a client account. In a preferred embodiment, time constraints for a discount period are also included in an analytics report if the discount period has been determined. In a preferred embodiment, an analytic view is generated tailored to a supplying entity and reported with documents, within a supplier account, or an integrate enterprise reporting platform. In a preferred embodiment, the analytic view generated includes updated order information and forecast demand levels to improve production efficiency. In one embodiment, forecast information may be based at least in part on other collective discount platforms, active or historical.

What is claimed is:

1. A method, comprising:
receiving a sale order listing a unit description, sale volume and a unit price;
activating the sale order on a collective discount platform;
receiving postponable purchase requests for the sale order over the collective discount platform;
establishing time constraints for receiving additional purchase requests when the postponable purchase requests received satisfies a collective volume discount value;
securely executing transactions for the postponable and additional purchase requests; and
sending confirmation of the securely executed transactions for purchase requests over the collective discount platform.

2. The method of claim 1, further comprising determining a discount period based on the collective volume discount value.

3. The method of claim 1, further comprising:
storing seller information, the sale order listing unit description, sale volumes, unit pricing, purchaser information, postponable purchase requests and other purchase requests in memory of a data store associated with the collective discount platform;
mapping relationships between seller information, the sale order listing unit description, sale volumes, unit pricing, purchaser information, postponable purchase requests and other purchase requests in memory of a data store associated with the collective discount platform; and
generating analytic views of the stored information and the mapped relationships.

4. The method of claim 1, further comprising
determining a purchase request total and a price-volume association; and
pricing the sale order based at least in part on the purchase request total and the price/volume association.

5. The method of claim 1, further comprising providing an application programming interface allowing the syndication of activated sale orders.

6. The method of claim 5, wherein providing the application programming interface further allows securely executing transactions through an affiliate site.

7. The method of claim 1, further comprising:
presenting a search component operable to receive a search query and a user identifier;
receiving the search query and user identifier from the search component; and
generating a result set responsive to the search query.

8. The method of claim 3, further comprising:
receiving an analytics report request;
retrieving, from the data store associated with the collective discount platform, information responsive to the analytics report request;
determining an analytics report format based on the analytics report request; and
generating the analytics report according to the determined report format.

9. The method of claim 8, further comprising distributing the generated analytics report over a heterogeneous network.

10. The method of claim 9 wherein the heterogeneous network includes a combination of a cellular network and a packet based network.

11. A computer system, comprising:
a discount engine configured to:
receive a sale order listing a unit description, sale volume and a unit price;
activate the sale order on a collective discount platform;
receive postponable purchase requests for the sale order over the collective discount platform;
establish time constraints for receiving additional purchase requests when the postponable purchase requests received satisfies a collective volume discount value;
a transaction engine configured to:
securely execute transactions for the postponable and additional purchase requests; and
send confirmation of the securely executed transactions for purchase requests over the collective discount platform.

12. The computer system of claim 11, wherein the discount engine is further configured to:
determine a discount period based on the collective volume discount value.

13. The computer system of claim 11, wherein the discount engine is further configured to:
store seller information, the sale order listing unit description, sale volumes, unit pricing, purchaser information, postponable purchase requests and other purchase requests in a data store; and further comprising:
a mapping engine configured to map relationships between seller information, the sale order listing unit description, sale volumes, unit pricing, purchaser information, postponable purchase requests and other purchase requests in memory of a data store associated with the collective discount platform; and
an analytics engine to generate analytic views of the stored information and the mapped relationships.

14. The computer system of claim 11, wherein the discount engine is further configured to:
determine a purchase request total and a price-volume association; and
price the sale order based at least in part on the purchase request total and the price/volume association.

15. The computer system of claim 11, further comprising an application programming interface allowing a developer client to access the collective discount platform through one or more API calls.

16. A computer readable medium having program instructions stored thereon, the program instructions being executable by a processor and when executed by the processor, cause the processor to:
receive a sale order listing a unit description, sale volume and a unit price;
activate the sale order on a collective discount platform;
receive postponable purchase requests for the sale order over the collective discount platform;
establish time constraints for receiving additional purchase requests when the postponable purchase requests received satisfies a collective volume discount value;
securely execute transactions for the postponable and additional purchase requests; and
send confirmation of the securely executed transactions for purchase requests over the collective discount platform.

17. The computer readable medium of claim 15, further including program instructions being executable by a processor and when executed by the processor, cause the processor to:
store seller information, the sale order listing unit description, sale volumes, unit pricing, purchaser information, postponable purchase requests and other purchase requests in memory of a data store associated with the collective discount platform;
map relationships between seller information, the sale order listing unit description, sale volumes, unit pricing, purchaser information, postponable purchase requests and other purchase requests in memory of a data store associated with the collective discount platform; and
generate analytic views of the stored information and the mapped relationships.

18. The computer readable medium of claim 15, further including program instructions being executable by a processor and when executed by the processor, cause the processor to:
determine a purchase request total and a price-volume association; and
price the sale order based at least in part on the purchase request total and the price/volume association.

19. The computer readable medium of claim 15, further including program instructions being executable by a processor and when executed by the processor, cause the processor to:
provide application programming interface allowing the syndication of activated sale orders.

20. The computer readable medium of claim 15, further including program instructions being executable by a processor and when executed by the processor, cause the processor to:
securely execute transactions through an affiliate site.

21. A method for placing and collectively discounting purchase order over a communication network, comprising:
receiving a sale order listing a unit description, sale volume and a unit price;
activating the sale order on a collective discount platform;
receiving postponable purchase requests for the sale order over the collective discount platform;
establishing time constraints for receiving additional purchase requests for the sale order over the collective discount platform when the postponable purchase requests received satisfies a collective unit demand value;
securely executing transactions for the postponable purchase requests and the additional purchase requests, wherein the postponable purchase requests and the additional purchase requests are executed at an initial price if a collective unit demand total, combined from the postponable purchase requests and the additional purchase requests, does not satisfy a demand volume, and further wherein the postponable purchase requests and additional purchase requests are executed with a supplementary discount if the collective unit demand satisfies a demand volume; and
sending a confirmation of the securely executed over the collective discount platform.

22. The method of claim 21, further comprising:
storing seller information, the sale order listing unit description, sale volumes, unit pricing, purchaser information, the postponable purchase requests and the additional purchase requests in memory of a data store associated with the collective discount platform;
mapping relationships between seller information, the sale order listing unit description, sale unit volumes, unit pricing, purchaser information, the postponable purchase requests and the additional purchase requests in memory of a data store associated with the collective discount platform; and
generating analytic views of the stored information and the mapped relationships.

23. The method of claim 22, wherein the mapping engine is operable to use client identifiers associated with purchaser information and stored by client systems for mapping relationships to enable the generation of analytic views without the submission or verification of information on multiple occurrences.

24. The method of claim 21, further comprising
determining a price-volume association; and
pricing the sale order based at least in part on the collective unit demand total and the price/volume association.

25. The method of claim 21, further providing an application programming interface allowing the syndication of activated sale orders.

26. The method of claim 25, wherein providing the application programming interface further allows securely executing transactions through an affiliate site.

27. The method of claim 21, further comprising:
presenting a search component operable to receive a search query and a user identifier;
receiving the search query and user identifier from the search component; and
generating a result set responsive to the search query.

28. The method of claim 22, further comprising:
receiving an analytics report request;
retrieving from the data store associated with the collective discount platform, information responsive to the analytics report request;
determining an analytics report format based on the analytics report request; and
generating the analytics report according to the determined report format.

29. The method of claim 28, further comprising distributing the generated analytics report over a heterogeneous network.

30. The method of claim 29, wherein the heterogeneous network includes a combination of a cellular network and a packet based network.

31. The method of claim 21, wherein securely executing transactions includes placing an authorization on provided purchaser information with the relevant financial service providers.

32. A computer system for placing and collectively discounting purchase orders via a communications network, comprising:
a collective discount platform configured to:
receive a sale order listing a unit description, sale volume, and a unit price;
activate the sale order;
receive postponable purchase requests for the sale order;
and subsequently receive additional purchase requests for the sale order;
a discount engine configured to:
establish time constraints for receiving the additional purchase requests when the postponable purchase requests received satisfies a collective unit demand value;
a transaction engine configured to:
securely execute transactions for the postponable purchase requests and the additional purchase requests, wherein the postponable purchase requests and the additional purchase requests are executed at an initial price if a collective unit demand total, combined from the postponable purchase requests and the additional purchase requests, does not satisfy a demand volume, and executed with a supplementary discount if the collective unit demand satisfies a demand volume; and
send a confirmation of the securely executed transactions over the collective discount platform.

33. The computer system of claim set 32, wherein the collective discount platform is further configured to:
store seller information, the sale order listing unit description, sale volumes, unit pricing, purchaser information, postponable purchase requests and additional purchase requests in a data store; and further comprising:
a mapping engine configured to map relationships between seller information, the sale order listing unit description, sale volumes, unit pricing, purchaser information, postponable purchase requests and additional purchase requests in memory of a data store associated with the collective discount platform; and
an analytics engine to generate analytic views of the stored information and the mapped relationships.

34. The computer system of claim 33, wherein the mapping engine is operable to use client identifiers associated with purchaser information and stored by client systems for mapping relationships to enable the generation of analytics views without the submission or verification of information on multiple occurrences.

35. The computer system of claim 32, wherein the discount engine is further configured to:
determine a price-volume association; and
price the sale order based at least in part on the collective unit demand total and the price/volume association.

36. The computer system of claim 32, further comprising an application programming interface allowing a developer client to access the collective discount platform through one or more API calls.

37. A computer readable medium having program instructions stored thereon, the program instructions being executable by a processor and when executed by the processor, cause the processor to:
receive a sale order listing a unit description, sale volume and a unit price;
activate the sale order on a collective discount platform;
receive postponable purchase requests for the sale order over the collective discount platform;
establish time constraints for receiving additional purchase requests for the sale order over the collective discount platform when the postponable purchase requests satisfies a collective unit demand value;
securely execute transactions for the postponable purchase requests and the additional purchase requests, wherein the postponable purchase requests and the additional purchase requests are executed at an initial price if a collective unit demand total, combined from the postponable purchase requests and the additional purchase requests, does not satisfy a demand volume, and executed with a supplementary discount if the collective unit demand total satisfies a demand volume; and
send a confirmation of the securely executed transactions over the collective discount platform.

38. The computer readable medium of claim 37, further including program instructions being executable by a processor and when executed by the processor, cause the processor to:
store seller information, the sale order listing unit description, sale unit volumes, unit pricing, purchaser information, the postponable purchase requests and the additional purchase requests in memory of a data store associated with the collective discount platform;
map relationships between seller information, the sale order listing unit description, sale unit volumes, unit pricing, purchaser information, the postponable purchase requests and the additional purchase requests in memory of a data store associated with the collective discount platform; and
generate analytic views of the stored information and the mapped relationships.

39. The computer readable medium of claim 37, further including program instructions being executable by a processor and when executed by the processor, cause the processor to:
determine a price-volume association; and
price the sale order based at least in part on the collective unit demand total and the price/volume association.

40. The computer readable medium of claim 37, further including program instructions being executable by a processor and when executed by the processor, cause the processor to:
securely execute transactions through an affiliate site.
